(19) United States
(12) Patent Application Publication
(10) Pub. No.: US 2024/0161045 A1
(43) Pub. Date: May 16, 2024

(54) SYSTEM, METHOD, AND COMPUTER PROGRAM FOR ASSISTING INTERVIEWERS

(71) Applicant: EIGHTFOLD AI INC., Santa Clara, CA (US)

(72) Inventors: Tushar Makkar, Haryana (IN); Ashutosh Garg, Santa Clara, CA (US)

(73) Assignee: EIGHTFOLD AI INC., Santa Clara, CA (US)

(21) Appl. No.: 17/986,152

(22) Filed: Nov. 14, 2022

(51) Int. Cl. G06Q 10/06; G10L 15/18

(52) U.S. Cl. CPC G06Q 10/06398; G06Q 10/063114; G10L 15/18

(57) ABSTRACT

An audio track capturing a conversation between an interviewer and an interviewee during an interview may be segmented, by executing a speaker identification engine, into a plurality of audio segments each being tagged as associated with one of the interviewer or the interviewee. A speech recognition and natural language processing (NLP) engine may be applied to the audio track to determine attributes associated with audio segments being tagged to the interviewer. The attributes may comprise timing parameters associated with the audio segment and a text content of the audio segment. A rule-based analysis engine may be executed, based on the attributes associated with audio segments being tagged to the interviewer, to determine whether the interviewer conducts the interview in compliance with predetermined rules. Responsive to determining that the interviewer does not conduct the interview in compliance with the predetermined rules, generating a notice regarding the non-compliance of the interview.

### TECHNICAL FIELD

The present disclosure relates to technical solutions that solve practical challenges in assisting interviewers to perform job interviews, and in particular to a system, method, and storage medium including executable computer programs for providing notices/suggestions to a job interviewer during/after a job interview.

### BACKGROUND

An organization may need to hire employees and contractors to fulfill job openings. The hiring process may include interviews of candidates by personnel associated with the organization (referred to herein as interviewers). The interviewers, through candidate interviews, may: evaluate and validate the skills of a candidate, obtain additional information about the candidate, introduce the organization and/or the job functions to the candidate, and/or establish a mutual understanding between the organization and the candidate.

Furthermore, the interview process itself may contribute to the branding of an organization. For example, candidates who have interviewed for a position with the organization (even when the candidates do not eventually join the organization) may provide positive accounts of the interview process to others, thus promoting the brand of the organization. Therefore, efficient systems and methods for assisting/training the interviewers to perform the job interviews may be very beneficial to any organization that conducts candidate interviews as part of their hiring process.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a computing system implementing an interviewer assistance application for assisting interviewers to perform job interviews according to an implementation of the disclosure.

FIG. 2 illustrates a machine learning module used to determine a match between predetermined rules and attributes based on determined similarities according to an implementation of the disclosure.

FIG. 3 illustrates the structure of a BERT neural network according to an implementation of the disclosure.

FIG. 4 illustrates a system for calculating the projection values of a predetermined rule on interviewer attributes according to an implementation of the disclosure.

FIG. 5 illustrates a flowchart of a method for assisting interviewers to perform candidate interviews, according to an implementation of the disclosure.

FIG. 6 depicts a block diagram of a computer system operating in accordance with one or more aspects of the present disclosure.

### DETAILED DESCRIPTION

A hiring process manager (e.g., a human resource manager, a technical manager, or an administrative assistant) may be responsible for assisting/training suitable interviewers associated with an organization to conduct interviews with a candidate for a position/job at the organization. The task of assisting/training interviewers to perform job interviews may require extra personnel and may often be very time-consuming. For a large organization with a large pool of potential interviewers, it may be difficult for the hiring process manager to personally evaluate the interviewers and contact each of them to assist/train them to conduct the interview properly according to organizational standards.

In practice, the hiring process manager often does not have enough time and/or personnel to adequately assist/train the many interviewers from a pool of interviewers of the large organization. Therefore, in a large organization, hiring process managers may be unaware of the respective skill levels possessed by each individual interviewer. This makes it difficult for the hiring process managers to evaluate each interviewer with respect to the organization's best practices regarding candidate interviews. Furthermore, the hiring process manager may rely on a manual process to identify problems and assist/train interviewers with said problems. However, a manual process is inefficient for the hiring process manager to evaluate/assist/train many interviewers in group. Still further, such a process may allow subjective criteria to influence the hiring process manager's evaluation of an interviewer's performance during a candidate interview. For example, the hiring process manager may evaluate interviewers based on arbitrary factors such as their personal relationships with the hiring process manager.

Therefore, there is a need for a technical solution including a system, method, and computer program that can automate the process to assess and/or assist interviewers in their performance of candidate interviews in an objective and uniform manner and optionally in real time during the interview. This may be accomplished based on an evaluation of an interviewer's performance based on predetermined rules, where the rules may take into account the organization's best practices regarding the performance of candidate interviews.

Implementations of the disclosure may provide a computer system which may include a software tool (referred to as an “interviewer helper”) implemented on a hardware processing device. Implementations of the disclosure may provide an intelligent system implemented by one or more computers for assessing and assisting interviewers with a candidate interview. The one or more computers may include a storage device (e.g., a memory) and a processing device, communicatively connected to the storage device, to obtain an audio track capturing a conversation between an interviewer and an interviewee during an interview. Segment, by executing a speaker identification engine, the audio track into a plurality of audio segments each being tagged as associated with one of the interviewer or the interviewee. Determine, by applying a speech recognition and natural language processing (NLP) engine to the audio track, attributes associated with audio segments being tagged to the interviewer, wherein the attributes associated with an audio segment comprise timing parameters associated with the audio segment and a text content of the audio segment. Execute a rule-based analysis engine based on the attributes associated with audio segments being tagged to the interviewer to determine whether the interviewer conducts the interview in compliance with predetermined rules. Responsive to determining that the interviewer does not conduct the interview in compliance with the predetermined rules, the intelligent system may generate a notice to a user regarding the non-compliance.

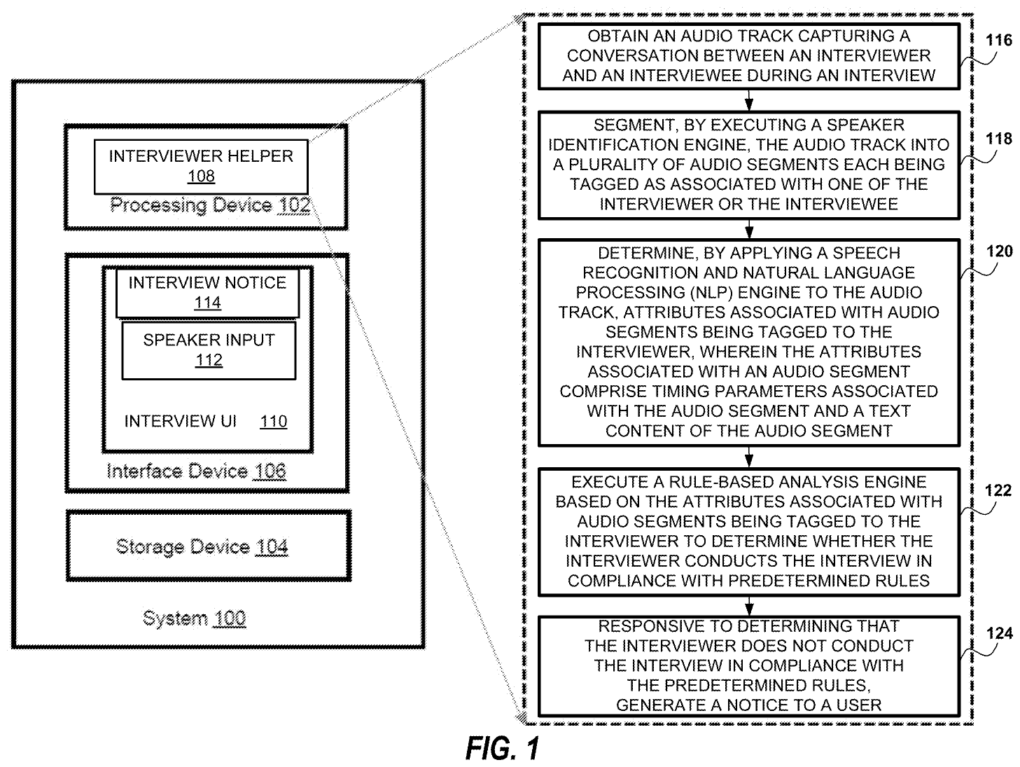

FIG. 1 illustrates a computing system 100 implementing an interviewer helper application 108 for assisting and training interviewers to perform candidate interviews according to an implementation of the disclosure. Interviewer helper application 108 in this disclosure may be an enterprise software application helping an organization to manage talent (e.g., select candidates for job openings). Computing system 100 may be a standalone computer or a networked computing resource implemented in a computing cloud. Referring to FIG. 1, computing system 100 may include one or more processing devices 102, a storage device 104, and an interface device 106 (e.g., microphone, headphones, computer display, keyboard, mouse, etc.) where the storage device 104 and the interface device 106 are communicatively coupled to processing devices 102.

Processing device 102 can be a programmable device that may be programmed to implement an interview user interface 110 via interface device 106. The interface device 106 may simply comprise one or more microphones to capture the audio track of the conversation during a candidate interview (e.g., speaker input 112) and/or headphones for the interviewer to receive assistance during the candidate interview (e.g., an interview notice 114 generated by interviewer helper 108). In some implementations, the interview user interface 110 may be a graphical user interface (“GUI”) to allow a user (e.g., hiring process manager, interviewer, etc.) to view graphic representations associated with candidate interviews presented on interface device 106 (e.g., an electronic display) and allow the user to use an input device (e.g., a keyboard, a mouse, and/or a touch screen) to interact with the graphic representations (e.g., icons) of, for example, lists of jobs, job candidates, potential candidate interviewers, a set of predetermined rules for conducting candidate interviews, and any generated interview notices 114 regarding potential problems identified by interviewer helper 108 during the performance of the candidate interview.

Computing system 100 may be connected to one or more remote information systems (not shown). These remote information systems may include one or more human resource management (HRM) systems that are associated with the same or different organizations. The HRM systems can track external/internal candidate information in a pre-hiring phase (e.g., using an applicant track system (ATS)), or track employee information after they are hired (e.g., using an HR information system (HRIS)). Thus, these information systems may include databases that contain information relating to job openings, candidates for these job openings, and current employees or interviewers associated with the organization or other organizations.

In some implementations, storage device 104 (and/or remote information systems) may include a database that stores predetermined rules associated with the organization's best practices for conducting candidate interviews. The predetermined rules may include rules that are associated with textual conversation elements (e.g., words, phrases, sentences, paragraphs) extracted from the audio track of the candidate interview and/or timing parameters associated with the textual conversation elements in the context of the entire candidate interview.

In some implementations, the predetermined rules may be associated with candidate information that should be addressed by an interviewer during a candidate interview. For example, the rules may be associated with a job title held by the candidate, the technical or non-technical skills possessed by the candidate for performing the job, and/or the location (e.g., city and state) of the candidate. Examples of technical skills may include programming languages and knowledge of software platforms; examples of non-technical skills may include administrative skills such as implementing a certain regulatory policy. The predetermined rules may also be associated with the candidate's education background information including schools attended, fields of study, and degrees obtained. The predetermined rules may also be associated with other professional information associated with the candidate such as professional certifications, achievement awards, professional publications, and technical contributions to public forums (e.g., open source code contributions).

In some implementations, predetermined rules may invoke specific questions for specific candidates. For example, questions relating to Java language may be automatically selected from question bank based on skills of the candidate who is being interviewed. The questions may include proficiency level questions pre-stored with advanced level questions, where the advanced level is more challenging than the proficiency level. Based on the response of the candidate, next question may be selected adaptively. For example, if an advanced question was given to the candidate and solved correctly by the candidate, then additional advanced questions may be given to the candidate again. However if the advanced question was not solved correctly, an easier question (e.g., a proficiency level question) may be given. Suggested question and solution may be presented on the screen of interviewer's personal computing device (e.g., PC) so that the interviewer can choose to give the suggested question or skip the one if candidate is not comfortable about the question. This also allows contemporaneous assessment of the candidate rather than writing assessment form at later stages.

In some implementations, the predetermined rules may be associated with different aspects of a job opening that should be addressed by an interviewer during a candidate interview. For example, the rules may be associated with job titles, job functions, prior experiences, a list of job skills requested for performing the job, requisite education, degrees, certificates, licenses etc. The predetermined rules may further be associated with desired personality traits of the candidates for a job opening such as leadership attributes and/or social attributes.

In some implementations, processing device 102 may execute interviewer helper application 108 that may assess and assist interviewers in performing candidate interviews in accordance with the predetermined rules for conducting candidate interviews discussed above. Interview helper application 108 may record the conversations between an interviewer and an interviewee in an audio track, and may include one or more machine learning modules (e.g., neural network modules) to process the audio track of the conversation between the interviewer and interviewee. These machine learning models may have been previously created/trained using a training data set (e.g., interview conversations). During the training step, parameters of the machine learning models may be modified until the performance interviewer helper application 108 reaches certain performance criteria. Comparing the textual conversation elements (e.g., words, phrases, sentences, paragraphs) extracted from the audio track of the candidate interview and/or the timing parameters associated with the textual conversation elements, interview helper application 108 may generate a set of notices 114 regarding any non-compliance of an interviewer with the predetermined rules for conducting candidate interviews.

The following sections describe interviewer helper application 108 in more detail through the flow diagram steps 116-124. In one implementation, the predetermined rules may have been previously created and stored in storage 104 (or in a remote information system). In this way, these predetermined rules may be available for interviewer helper application 108 to retrieve from a database of storage 104.

Referring to FIG. 1, at 116, processing device 102 may obtain an audio track capturing a conversation between an interviewer and an interviewee during an interview. As discussed above, the interface device 106 may include one or more microphones to capture the audio track of the conversation during an interview and/or headphones for the interviewer to receive assistance during the interview (e.g., a notice 114 generated by interviewer helper 108). The capture audio track may include the audio signal stored in an audio file of a certain audio file format such as, for example, mp3, advanced audio coding (ACC) etc.

At 118, processing device 102 may segment, by executing a speaker identification engine, the audio track into a plurality of audio segments each being tagged as associated with one of the interviewer or the interviewee. In order to determine which parts of the audio track are spoken by the interviewer or interviewee, a speaker identification model may be used. These speaker identification models may be fine-tuned using audio samples of each interviewer of a given organization in order to achieve high accuracy recognition of said interviewers. The speaker identification models can be trained according to a speaker-dependent model or a speak-independent model. In a speaker-dependent model, the interviewers may provide speech training samples in training the speaker identification model. The speaker-dependent model may produce more accurate speech recognition results because the model is trained using the speakers' speech sample data. When the speakers are not known in advance, the speaker identification model may be trained using speaker-independent sample datasets such as those public training datasets. The segmentation step may divide the audio track into a series of audio segments, and label each audio segment as associated with the interviewer or the interviewee.

At 120, processing device 102 may determine, by applying a speech recognition and natural language processing (NLP) engine to the audio track, attributes associated with audio segments being tagged to the interviewer, wherein the attributes associated with an audio segment comprise timing parameters associated with the audio segment and a text content of the audio segment. After the audio is segmented and tagged per speaker using the speaker identification model, it may be forwarded to the NLP engine for analysis of the text per speaker and determination of attributes based on the text. The NLP engine may determine attributes associated with an audio segment of the conversation including timing parameters associated with said audio segment and text content of said audio segment. A rule-based analysis engine (described further below) may then compare the determined attributes with the predetermined rules for conducting interviews according to the best practices of the organization. Furthermore, the NLP engine may determine attributes such as verbosity, content clarity, concept clarity, confidence etc. associated with an interviewer on the basis of attributes determined from audio segments being tagged to the interviewer.

At 122, processing device 102 may execute a rule-based analysis engine based on the attributes associated with audio segments being tagged to the interviewer to determine whether the interviewer conducts the interview in compliance with the predetermined rules. The output of NLP engine (e.g., attributes) is fed into the rule-based analysis engine which may compare them to the predetermined rules (e.g., applying the rules) that have been saved (e.g., in storage 104). The predetermined rules for conducting interviews according to the best practices of the organization may comprise timing data and content data and to determine whether the interviewer conducts the interview in compliance with the predetermined rules, the rule-based analysis engine is further to: access the database of predetermined rules; compare the timing parameters and text content of each attribute, associated with audio segments being tagged to the interviewer, to the respective timing data and content data of each rule in the database to determine a match.

Some implementations may create a domain specific language for the rules (e.g., JSON). For example, a predetermined rule may be composed using a java script object notation (JSON) file including two fields: one for timing data and one for content data. The content field may include a function call (e.g., to a python function) to evaluate the text content of an attribute with respect to the content data of the predetermined rule. A database of predetermined rules (e.g., in storage 104) may include some sample rules for interviews in a library and other rules for interviews may be formulated by an organization (and saved in the database) as and when required. For example, a sample rule for interviews may be that “within the first 5 minutes of an interview, the interviewer should tell the interviewee about his work at the current organization”. A JSON file may be used to save this rule in the database:

```
{
  ‘timing’: [0, 5*60],
  ‘content’: {
      ‘function_name’: “include_similar_string”,
      ‘value’: [“My work here includes”, “I work on”]
    }
}
```

As noted above, the content field of the JSON file may include a function call (e.g., ‘function_name’) to an “include_similar_string” function implemented in the rules-based analysis engine. The content field may also include a ‘value’ which may comprise sample text strings associated with subject matter that should be present in the interviewer's speech. The “include_similar_string” function may find the embedding of the values present in each value field of the rules and attempt to find similar text strings in the attributes determined from audio segments tagged to the interviewer's speech. This similarity between text strings may be found using a transformer based machine learning model. Accordingly, the function call may include a call to a bidirectional encoder representations from transformers (BERT) network and the BERT network may be trained to determine a similarity between the timing parameters and text content of each attribute, associated with audio segments being tagged to the interviewer, and the timing data and value text strings (e.g., content data) of each predetermined rule. For example, if the text content of an attribute determined from audio segments tagged to the interviewer includes the text string “My project revolves around . . . ” then the “include_similar_string” function may determine that this text string is similar to the values “My work here includes” and/or “I work on” mentioned above and therefore the interviewer is in compliance with this particular predetermined rule, if the interviewer also complies with the timing parameters “[0, 5*60]” associated with the predetermined rule (e.g., a similar text string is found within first five minutes of interview). Other sample rules may be that the interviewer should greet the candidate at the start of the interview or that the interviewer should ask at least 2 programming questions from the interviewee during the course of the interview.

At 124, processing device 102 may, responsive to determining that the interviewer does not conduct the interview in compliance with the predetermined rules (e.g., there is a predetermined rule for which there is no matching interviewer attribute), generate a notice 114 to a user. In some implementations the database of predetermined rules may also include notices 114 associated with non-compliance of an interviewer with each of the predetermined rules and one or more of these notices 114 may be provided to a user (e.g., hiring process manager, interviewer, etc.) based on a determination that the interviewer has not complied with one or more of the predetermined rules during the course of the interview conversation. In some implementations the notices 114 may be provided to the interviewer (e.g., via interview UI 110) in real time during the interview conversation in order to assist the interviewer during the interview. In some implementations the notice 114 may include a summary of the interview conversation and it may be provided to the interviewer/hiring process manager to assist in reviewing the interview. In alternative implementations these notices 114 may be generated “on the fly” by the rules-based analysis engine based on which ones of the predetermined rules have not been complied with by the interviewer.

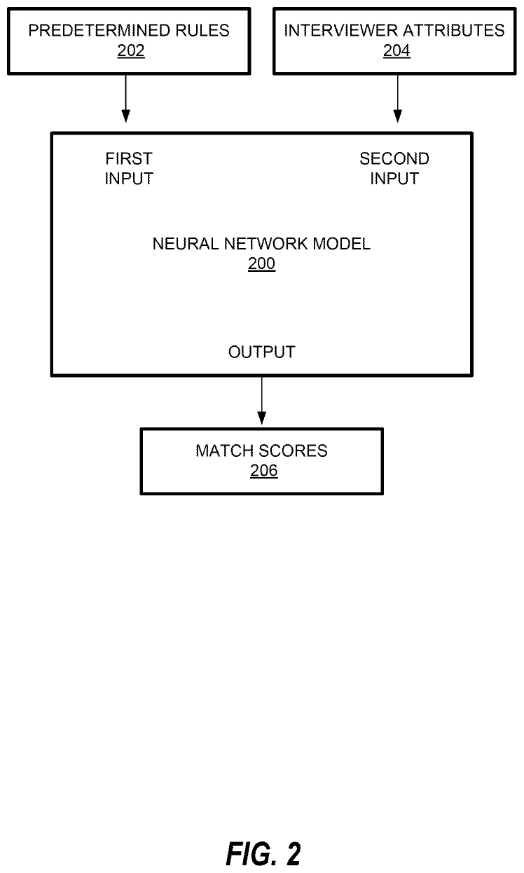

In some implementations, the rules-based analysis engine may comprise a bidirectional encoder representations from transformers (BERT) network module comprising an input layer to receive data inputs of the attributes and of predetermined rules for conducting interviews, one or more hidden layers comprising neurons to calculate based on the data inputs, and an output layer to output match scores each indicating a compliance of an attribute with a corresponding one of the predetermined rules for conducting interviews (see FIG. 2 below).

FIG. 2 illustrates a machine learning module used to determine a match between predetermined rules and attributes based on determined similarities according to some embodiments described herein. As shown in FIG. 2, the machine learning module may include a neural network model 200 (e.g., part of a rules-based analysis engine) that receives data inputs including first data inputs for receiving predetermined rules 202 and second data inputs for receiving interviewer attributes 204 determined from audio segments tagged to the interviewer. Processing device 102 may further execute neural network model 200 to calculate match scores 206 as outputs. Each of the match scores may represent how well a corresponding interviewer attribute 204 complies with a predetermined rule 202 for conducting candidate interviews. As noted above, the predetermined rules 202 may comprise a list of elements/aspects that may need to be explicitly or implicitly addressed by the interviewer during the candidate interview. These elements/aspects may include knowledge-based elements (e.g., required job skills) and/or social skill aspects (e.g., personal characteristics, team work, independent work etc.) The compliance of the interviewer with the predetermined rules 202 during the interview may be based on how well the interviewer addresses these different elements/aspects during the interview. In one implementation, each of the calculated match scores 206 can be a numerical value within a range (e.g., [0, 1] with 1 indicating the highest match) that reflects the overall compliance of the interviewer with the predetermined rules 202 during the interview.

In one implementation, processing device 102 may execute neural network model 200, to calculate a respective match score 206 for each interviewer attribute 204 with respect to each of the predetermined rules 202 for conducting the interview and construct a list of notices 114 to a user (e.g., hiring process manager, interviewer, etc.) in a ranking order based on the match score 206 values (e.g., higher ranking order for lower match score 206 value) so that the most egregious non-compliance of the interviewer with the predetermined rules 202 during the interview is ranked highest.

Machine learning in this disclosure refers to methods implemented on hardware processing device that uses statistical techniques and/or artificial neural networks to give computer the ability to “learn” (i.e., progressively improve performance on a specific task) from data without being explicitly programmed Machine learning may use a parameterized model (referred to as “machine learning model”) that may be deployed using supervised learning/semi-supervised learning, unsupervised learning, or reinforced learning methods. Supervised/semi-supervised learning methods may train the machine learning models using labeled training examples. To perform a task using a supervised machine learning model, a computer may use examples (commonly referred to as “training data”) to test the machine learning model and to adjust parameters of the machine learning model based on a performance measurement (e.g., the error rate). The process to adjust the parameters of the machine learning mode (commonly referred to as “train the machine learning model”) may generate a specific model that is to perform the practical task it is trained for. After training, the computer may receive new data inputs associated with the task and calculate, based on the trained machine learning model, an estimated output for the machine learning model that predicts an outcome for the task. Training examples may include input data and corresponding desired output data, where the data can be in a suitable form such as a vector of numerical alphanumerical symbols.

The learning process may be an iterative process. The process may include a forward propagation process to calculate an output based on the machine learning model and the input data fed into the machine learning model, and then calculate a difference between the desired output data and the calculated output data. The process may further include a backpropagation process to adjust parameters of the machine learning model based on the calculated difference. Unsupervised learning methods may find structure in data based on only the input data. Thus, unsupervised learning methods may learn about commonalities about the data from test data that are not labeled, classified, or categorized. Unsupervised learning methods may identify commonalities in a dataset and make decisions based on the presence/absence of the commonalities in the dataset. Reinforced learning methods may use agents (e.g., software agents) to react in an environment so as to maximize a reward function. The environment can be represented using a decision process. Reinforced learning methods may assume no knowledge of the exact mathematical model of the decision process and thus can be used when the exact model is difficult to determine.

In one implementation, a neural network model is a deep neural network (DNN) implemented on processing device 102. A DNN may include multiple layers, in particular including an input layer for receiving data inputs, an output layer for generating outputs, and one or more hidden layers that each includes linear or non-linear computation elements (referred to as neurons) to perform the DNN computation propagated from the input layer to the output layer that may transform the data inputs to the outputs. Two adjacent layers may be connected by edges. Each of the edges may be associated with a parameter value (referred to as a synaptic weight value) that provides a scale factor to the output of a neuron in a prior layer as an input to one or more neurons in a subsequent layer.

The synaptic weight values are determined by a training process of the DNN. During the training process, synaptic weight values may be tuned to perform the specific task of comparing predetermined rules 202 to interviewer attributes 204. The training may be carried out using training data that may include pairs of data inputs and corresponding target outputs. These pairs may have been generated and labeled based on prior interviews where interviewers address the one or more elements/aspects of the predetermined rules 202 for conducting interviews. The prior interviews used as the training data may include positive examples where the interviewers effectively address the one or more elements/aspects (e.g., either in possession of or lack of one or more skills required for the job) required by the predetermined rules 202. The prior interviews used as the training data may optionally also include negative examples where the interviewers does not effectively address the one or more elements/aspects required by the predetermined rules 202.

As natural language “documents”, the interviewer attributes 204 may be projected on to each of predetermined rules 202 to calculate a respective similarity value between two documents. There are many ways to compare the similarity between two natural language documents using machine learning techniques. In most applications, the machine learning modules used for comparing the similarity between two natural language documents need to be trained for specific tasks. The task-specific training requires training data labeled for the task. When the machine learning model is a deep neural network, the data required to train the neural network can be very large and very expensive to generate.

To overcome these and other technical challenges, implementations of the disclosure employ Bidirectional Encoder Representations from Transformers (BERT) machine learning models to calculate the projection value or similarity value between each interviewer attribute 204 and each predetermined rule 202 for conducting interviews. In this disclosure, the BERT model includes different variations of BERT models including, but not limited to, ALBERT (a Lite BERT for Self-Supervised Learning of Language Representations), ROBERTA (Robustly Optimized BERT Pre-training Approach), and DistillBERT (a distilled version of BERT). The BERT models may include a general purpose machine learning model and an output layer. The general purpose machine learning model can be trained using unannotated text data (e.g., those available on the world-wide web) while the output layer which is commonly a single layer that may be trained using a small amount of training data annotated to the specific task. In this way, the requirement for the amount of training data and the time for training may be significantly reduced, thus achieving efficient implementations of a neural network.

To achieve deeper understanding of the underlying text, BERT employs bidirectional training. Instead of identifying the next word in a sequence of words, BERT may use a technique called Masked Language Modeling (MLM) that may randomly mask words in a sentence and then try to predict the masked words from other words in the sentence surrounding the masked words from both left and right of the masked words. Thus, the training of the machine learning model using BERT takes into consideration words from both directions simultaneously during the training process.

A word in a document may be represented using a word embedding which can be a vector of numbers that may be derived based on a linguistic model. The linguistic model can be context-free or context-based. An example of the context-free model is word2vec that may be used to determine the vector representation for each word in a vocabulary. In contrast, context-based models may generate a word embedding associated with words based on other words in the sentence. In BERT, the word embedding associated with a word may be calculated based on other words within the input document using the previous context and the next context.

A transformer neural network (referred to as the “Transformer” herein) is designed to overcome the deficiencies of other types of neural networks such as the recurrent neural network (RNN) or the convolutional neural network (CNN), thus achieving the determination of word dependencies among all words in a sentence with fast implementations using TPUs and GPUs. The Transformer may include encoders and decoders (e.g., six encoders and six decoders), where encoders have identical or very similar architecture, and decoders may also have identical or very similar architecture. The encoders may encode the input data into an intermediate encoded representation, and the decoder may convert the encoded representations to a final result. An encoder may include self-attention layers and a feed forward layer. The self-attention layers may calculate attention scores associated with a word. The attention scores, in the context of this disclosure, measure the relevance values between the word and each of the other words in the sentence. Each relevance may be represented in the form of a weight value.

In some implementations, the self-attention layer may receive the word embedding of each word as input. The word embedding can be a vector including 512 data elements. The self-attention layer may further include a projection layer that may project the input word embedding vector into a query vector, a kay vector, and a value vector which each has a lower dimension (e.g., 64). The scores between a word and other words in the input sentence are calculated as the dot product between the query vector of the word and key vectors of all words in the input sentence. The scores may be fed to a Softmax layer to generate normalized Softmax scores that each determine how much each word in the input sentence is expressed at the current word position. The attention layer may further include the multiplication operations that multiply the Softmax scores with each of the value vectors to generate the weighted scores that may maintain the value of words that are focused on while reducing the attention to the irrelevant words. Finally, the self-attention layer may sum up the weighted scores to generate the attention values at each word position. The attention scores are provided to the feed forward layer. The calculations in the feedforward can be performed in parallel while the relevance between words is reflected in the attention scores.

Each of the decoders may similarly include a self-attention layer and a feed forward layer. The decoder may receive input and information from the encoder. Thus, a BERT system may be constructed using the transformer neural network trained using unannotated text documents.

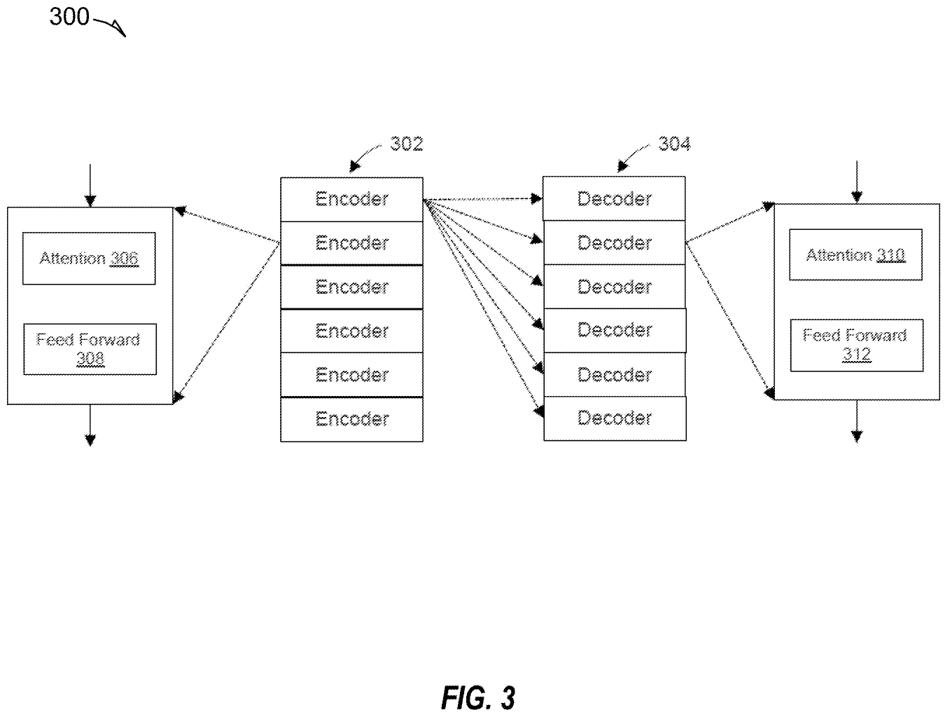

FIG. 3 illustrates the structure of a BERT neural network 300 according to an implementation of the disclosure. Referring to FIG. 3, BERT neural network 300 may include stacked-up encoders 302 coupled to stacked-up decoders 304. In one implementation, BERT neural network 300 may include six (6) stacked-up encoders 302 and six (6) stacked-up decoders 304. The encoders therein may sequentially process input data which in this disclosure is a segment of word embeddings from a natural language document (e.g., interviewer attributes 204). A first encoder in the stacked-up encoders 302 may receive a segment of word embeddings from the document, and then process to generate a first encoded representation output. The output of the first encoder may be fed as the input data to a second encoder in the stacked-up encoders 302 to generate a second encoded representation output. In this way, the segment of word embeddings may be sequentially processed through to generate a final encoded representation output.

The decoders therein may receive the encoded representation outputs (e.g., any one of the first through the final encoded representation output) from stacked-up encoders 302, and sequentially process to generate the final results.

In one implementation, each encoder in stacked-up encoders 302 may include a common architecture, and similarly, each decoder in stacked-up decoders 304 may also include a common architecture. As shown in FIG. 3, each encoder may include an attention layer 306 and a feed forward layer 308. Attention layer 306 can be a self-attention layer that may calculate vectors of attention scores for input data, where a vector of attention scores associated with an input data point may represent the relevancies between the present input data point with other input data points. In the example of natural language text documents, the attention layer 306 of the first encoder may receive the word embeddings and calculate a respective vector of attention scores for each word embedding. The vector of attention scores may represent the relevancies between the present word embedding (or word) with other word embeddings (or words) in the segment. The vectors of attention scores may be fed into the feed forward layer 308. Feed forward layer 308 may perform linear calculations that may transform the vectors of attention scores into a form that may be fed into a next encoder or decoder. Since the vectors of attention scores are independent from each other, the calculations of feed forward layer 308 can be performed in parallel using TPUs or GPUs to achieve higher computation efficiency.

Similarly, each decoder in stacked-up decoders may also include an attention layer 310 and a feed forward layer 312. In a practical application such as machine translation between two different languages, the document containing the source language may be fed into the stacked-up encoders, and the documents containing the target language may be fed into the stacked-up decoders during the training process. In one implementation, stacked-up encoders 302 and stacked-up decoders 304 are fully connected, meaning each decoder may receive not only the final but all intermediate encoded representation outputs from stacked-up encoders 302. The stacked-up decoders 304 may generate an output vector of a fixed length (e.g., 512) for the BERT neural network. The output vector may represent relevance parameters, wherein each of the of relevance parameters represents a contextual relevancy between a current word with another word in the section.

BERT neural network 300 may be trained using unannotated text data. The output vectors from the transformer layer may be fed, as input data, into an output layer that may be trained using task-specific training data. In one implementation, the output layer may include two sequence-to-sequence layers. A first sequence-to-sequence layer may include nodes that are sequentially connected to form a forward processing pipeline, and a second sequence-to-sequence layer may include nodes that are sequentially connected to form a reverse processing pipeline. The forward direction in this disclosure may represent from the beginning to the end of a predetermined rule 202 or an interviewer attribute 204. The reverse direction in this disclosure represents from the end to the beginning of a predetermined rule 202 or an interviewer attribute 204. By processing the outputs from BERT layer 302 in both directions, implementations may take into account the context information from both directions for each word in the input document (e.g., predetermined rule 202 or interviewer attribute 204).

When the document includes texts that are longer than the fixed length of the BERT neural network, multiple BERT neural networks may work in parallel to process the document. In addition to the input data from a BERT neural network, each node in sequence-to-sequence layers may receive retained information from a previous node in the sequence-to-sequence processing pipeline, thus providing further context information to the present node. The retained information received from the previous node may encode the local context information (short term memory) and optionally, remote context information (long term memory). Example sequence-to-sequence nodes may be composed of recurrent neural network (RNN) nodes, long and short-term memory (LSTM) nodes, additional transformer layers that are trained using application-specific training data, linear layers, and convolutional neural network (CNN) layers.

Since each of sequence-to-sequence layers is calculated sequentially in order, the node calculation in sequence-to-sequence layer is implemented for sequential calculations. In one implementation, the parameters of nodes in the sequence-to-sequence layer are served as the output layer and are trained using task-specific annotated training data set. Since BERT neural networks are trained using unannotated data, they can be available off-the-shelves in advance. Then, a small set of training dataset labeled for a specific task is needed to train both sequence-to-sequence layers using the off-the-shelves BERT neural networks. In this way, the task-specific output layers may be fine-tuned using a small training dataset.

Thus, a BERT neural network and an output layer may constitute a BERT system that may be employed to process a document (e.g., predetermined rule 202 or interviewer attribute 204) and generate a BERT output vector representing the document. The similarity between two documents (e.g., between a predetermined rule 202 and an interviewer attribute 204) can be calculated as a projection or a dot product of the two BERT output vectors.

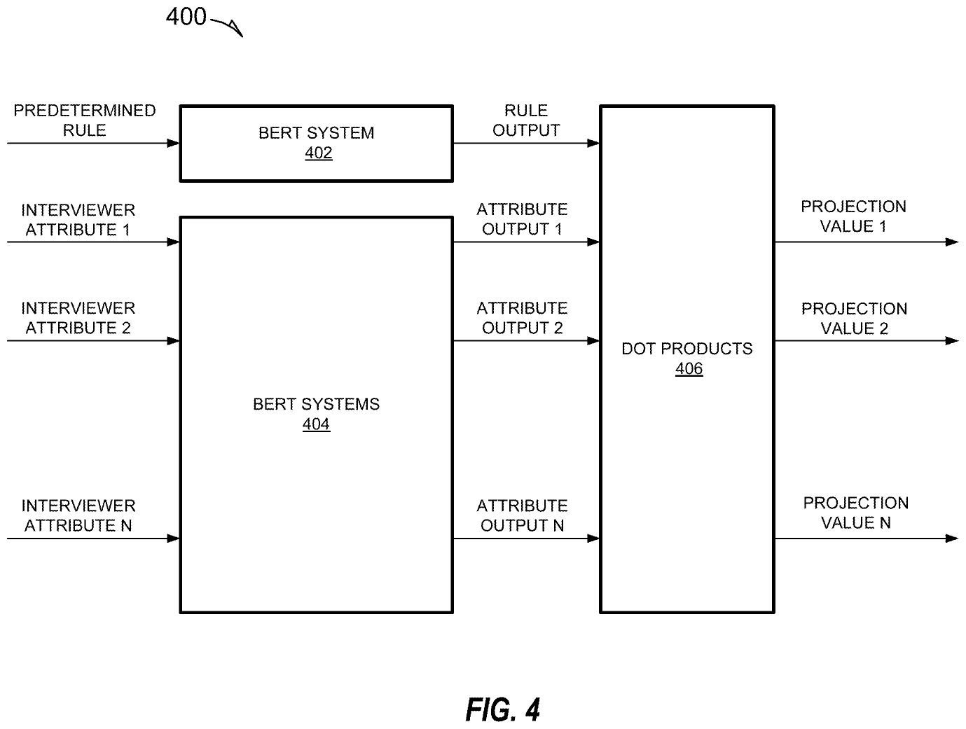

FIG. 4 illustrates a system 400 for calculating the projection values of a predetermined rule on interviewer attributes, according to an implementation of the disclosure. As shown in FIG. 4, system 400 may include BERT system 402 and BERT systems 404 which both may be implemented on a processing device (e.g., processing device 102 of FIG. 1). Each of BERT systems 402 and 404 may include a BERT neural network and an output layer, where the BERT neural network may be trained using unannotated data and the output layer may be trained using task-specific annotated data. In one implementation, BERT system 402 and BERT systems 404 can be discrete implementations that run in parallel. In another implementation, BERT system 402 and BERT systems 404 can be a single implemented system that processes input documents (e.g., predetermined rules 202 and interviewer attributes 204 of FIG. 2) sequentially.

BERT system 402 may receive the predetermined rule (e.g., 202 of FIG. 2) as input and generates a rule BERT output vector which can be a vector containing numerical values. BERT systems 404 may receive the interviewer attributes (1, 2 . . . N), and generate corresponding attribute BERT output vectors (1, 2 . . . N) which each can be a vector containing numerical values. To further calculate the similarities between the predetermined rule and each one of the interviewer attributes (1, 2, . . . N), system 400 may include a dot product component 406 to calculate the dot product values between the rule BERT output vector and each one of attribute BERT output vectors (1, 2, . . . N). The outputs of dot product component 406 may include corresponding projection values (1, 2 . . . N) that each represents the similarity between the predetermined rule and the each of the interviewer attributes.

Based on the similarity between the timing data and content data of a predetermined rule and the timing parameters and text content of any of the interviewer attributes being sufficient (e.g., greater than a threshold value) it may be determined (e.g., by interviewer helper 108 of FIG. 1) that the interviewer attribute is a match for the predetermined rule and therefore the interviewer has complied with the predetermined rule during the course of the candidate interview. However, based on the similarity between the timing data and content data of a predetermined rule and the timing parameters and text content of any of the interviewer attribute being insufficient (e.g., less than a threshold value) it may be determined the interviewer attribute is a match for the predetermined rule and therefore the interviewer has not complied with the predetermined rule during the course of the candidate interview and a notice regarding the non-compliance may be provided to a user (e.g., via interviewer UI 110 of FIG. 1). This process may be repeated for each predetermined rule in order to determine whether the interviewer has complied with all of the predetermined rules for conducting the interview according to the required organizational standards.

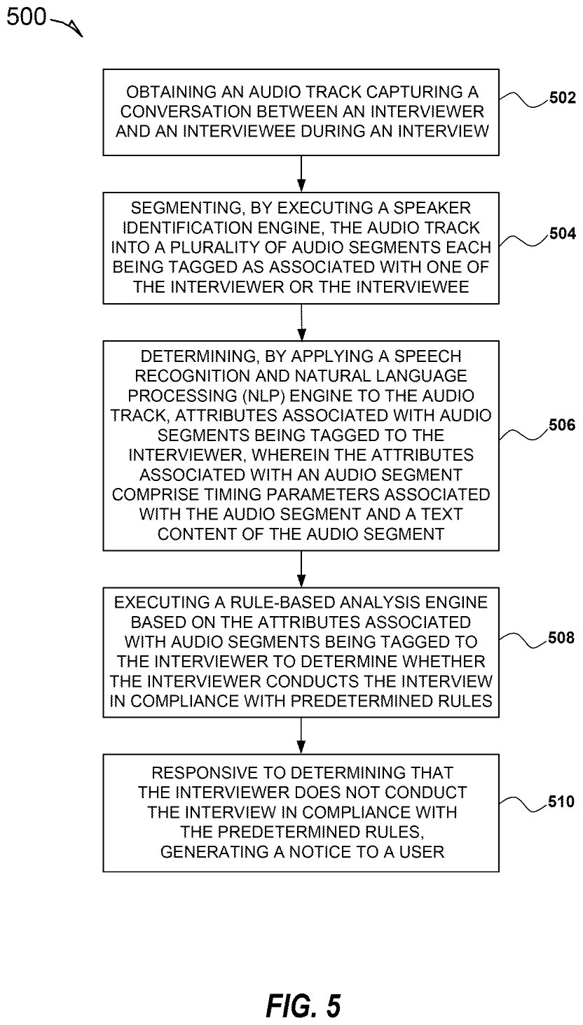

FIG. 5 illustrates a flowchart of a method 500 for assisting interviewers to perform candidate interviews according to an implementation of the disclosure. Method 500 may be performed by processing devices that may comprise hardware (e.g., circuitry, dedicated logic), computer readable instructions (e.g., run on a general purpose computer system or a dedicated machine), or a combination of both. Method 500 and each of its individual functions, routines, subroutines, or operations may be performed by one or more processors of the computer device executing the method. In certain implementations, method 500 may be performed by a single processing thread. Method 500 may also be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 500 may be performed by a processing device 102 executing interviewer helper 108 as shown in FIG. 1.

As shown in FIG. 5, at 502, obtaining an audio track capturing a conversation between an interviewer and an interviewee during an interview. As discussed above, the interface device 106 may simply comprise one or more microphones to capture the audio track of the conversation during an interview.

At 504, segmenting, by executing a speaker identification engine, the audio track into a plurality of audio segments each being tagged as associated with one of the interviewer or the interviewee. In order to determine which parts of the audio track are spoken by the interviewer or interviewee, a speaker identification model that may be fine-tuned using audio samples of each interviewer of a given organization in order to achieve high accuracy recognition of said interviewers may be used.

At 506, determining, by applying a speech recognition and natural language processing (NLP) engine to the audio track, attributes associated with audio segments being tagged to the interviewer, wherein the attributes associated with an audio segment comprise timing parameters associated with the audio segment and a text content of the audio segment. After the audio is segmented and tagged per speaker using the speaker identification model it may be sent to the NLP engine for analysis of the text per speaker and determination of attributes based on the text. The NLP engine may determine attributes associated with an audio segment of the conversation including timing parameters associated with said audio segment and text content of said audio segment.

At 508, executing a rule-based analysis engine based on the attributes associated with audio segments being tagged to the interviewer to determine whether the interviewer conducts the interview in compliance with the predetermined rules. The output of NLP engine (e.g., attributes) is fed into the rules-based analysis engine which may compare them to the predetermined rules (e.g., applying the rules) that have been saved (e.g., in storage 104). The predetermined rules for conducting interviews according to the best practices of the organization may comprise timing data and content data and to determine whether the interviewer conducts the interview in compliance with the predetermined rules, the rule-based analysis engine may access a database of predetermined rules; compare the timing parameters and text content of each attribute, associated with audio segments being tagged to the interviewer, to the respective timing data and content data of each predetermined rule to determine a match between the attribute and the predetermined rule.

At 510, responsive to determining that the interviewer does not conduct the interview in compliance with the predetermined rules, generating a notice 114 to a user. As noted above, the notices 114 may be provided to the interviewer (e.g., via interview UI 110) in real time during the interview conversation in order to assist the interviewer during the interview. Also as noted above, the notice 114 may comprise a summary of the interview conversation and it may be provided to the interviewer/hiring process manager to assist in reviewing the interview. The content of the notice 114 may be based on the predetermined rules for which there are no matching interviewer attributes. For example, the content may include: “No mention of interviewer's work at the organization within the first five minutes of the conversation during the interview”.

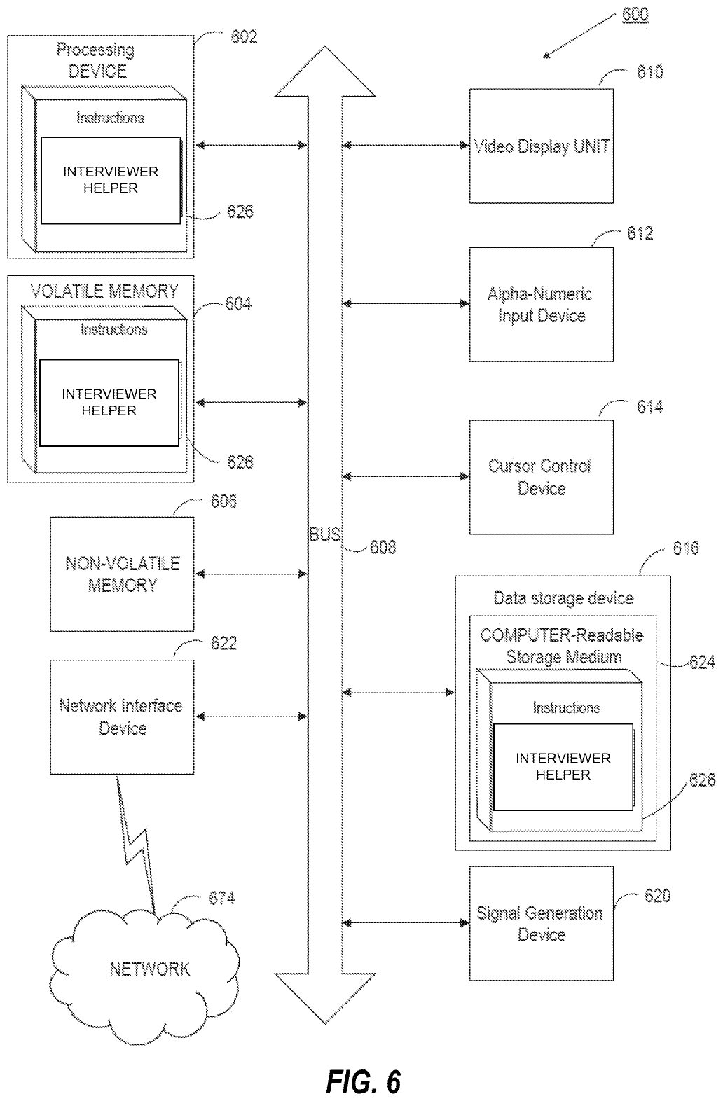

FIG. 6 depicts a block diagram of a computer system operating in accordance with one or more aspects of the present disclosure. In various illustrative examples, computer system 600 may correspond to the processing device 102 of FIG. 1.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions of the interviewer helper 108 of FIG. 1 for implementing method 500.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 500 and/or each of its individual functions, routines, subroutines, or operations. Examples of the structure for a variety of these systems are set forth in the description above.

The above description and accompanying figures are intended to be illustrative, and not restrictive. The scope of the present disclosure should be determined with reference to the following claims, along with the full scope of equivalents to which the claims are entitled.

1. A system implemented by one or more computers to assist interviewers in performing interviews, the one or more computers comprising:
a storage device; and
a processing device, communicatively connected to the storage device, to:
obtain an audio track capturing a conversation between an interviewer and an interviewee during an interview;
segment, by executing a speaker identification engine, the audio track into a plurality of audio segments each being tagged as associated with one of the interviewer or the interviewee;
determine, by applying a speech recognition and natural language processing (NLP) engine to the audio track, attributes associated with audio segments being tagged to the interviewer, wherein the attributes associated with an audio segment comprise timing parameters associated with the audio segment and a text content of the audio segment;
execute a rule-based analysis engine based on the attributes associated with audio segments being tagged to the interviewer to determine whether the interviewer conducts the interview in compliance with predetermined rules; and
responsive to determining that the interviewer does not conduct the interview in compliance with the predetermined rules, generate a notice to a user.

2. The system of claim 1, wherein the rule-based analysis engine comprises a bidirectional encoder representations from transformers (BERT) network.

3. The system of claim 2, wherein:
the storage device comprises a database of the predetermined rules;
each predetermined rule comprises at least one of timing data or content data; and
to determine whether the interviewer conducts the interview in compliance with the predetermined rules, the processing device is further to:
compare the timing parameters and text content of each attribute, associated with audio segments being tagged to the interviewer, to the timing data and the content data of at least one predetermined rule in the database to determine a match between the attribute and the predetermined rule; and
determine, based on each match, that the interviewer does not conduct the interview in compliance with the respective matching predetermined rule.

4. The system of claim 3, wherein the processing device is further to determine, based on the at least one predetermined rule for which there is no matching attribute, a respective content of the notice to the user.

5. The system of claim 4, wherein the content data of each predetermined rule comprises a function call and a value comprising text strings.

6. The system of claim 5, wherein:
the function call comprises a call to the BERT network; and
the BERT network is trained to determine a similarity between the timing parameters and text content of each attribute, associated with audio segments being tagged to the interviewer, and the respective timing data and content data of each predetermined rule.

7. The system of claim 6, wherein the processing device is further to determine the match between the attribute and the predetermined rule based on the determined similarity between the timing parameters and text content of the attribute and the respective timing data and content data of the predetermined rule being greater than a predetermined threshold value.

8. The system of claim 1, wherein:
each attribute associated with audio segments being tagged to the interviewer comprises a characterization of the text content of the attribute; and
the characterization is based on at least one of a verbosity, a content clarity, a concept clarity and a confidence of the interviewer during the conversation.

9. The system of claim 1, wherein the processing device is further to provide the notice to the user in real time during the conversation.

10. The system of claim 1, wherein the notice to the user comprises a summary of the conversation between the interviewer and the interviewee during the interview.

11. A method implemented by one or more computers to assist interviewers in performing interviews, the method comprising:
obtaining, by a processing device communicatively connected to a storage device, an audio track capturing a conversation between an interviewer and an interviewee during an interview;
segmenting, by executing a speaker identification engine, the audio track into a plurality of audio segments each being tagged as associated with one of the interviewer or the interviewee;
determining, by applying a speech recognition and natural language processing (NLP) engine to the audio track, attributes associated with audio segments being tagged to the interviewer, wherein the attributes associated with an audio segment comprise timing parameters associated with the audio segment and a text content of the audio segment;
executing a rule-based analysis engine based on the attributes associated with audio segments being tagged to the interviewer to determine whether the interviewer conducts the interview in compliance with predetermined rules; and
responsive to determining that the interviewer does not conduct the interview in compliance with the predetermined rules, generating a notice to a user.

12. The method of claim 1, wherein the rule-based analysis engine comprises a bidirectional encoder representations from transformers (BERT) network.

13. The method of claim 12, wherein:
the storage device comprises a database of the predetermined rules;
each predetermined rule comprises at least one of timing data or content data; and
the method further comprises determining whether the interviewer conducts the interview in compliance with the predetermined rules based on:
comparing the timing parameters and text content of each attribute, associated with audio segments being tagged to the interviewer, to the timing data and the content data of at least one predetermined rule in the database to determine a match between the attribute and the predetermined rule; and
determining, based on each match, that the interviewer does not conduct the interview in compliance with the respective matching predetermined rule.

14. The method of claim 13, further comprising determining, based on the at least one predetermined rule for which there is no matching attribute, a respective content of the notice to the user.

15. The method of claim 14, wherein the content data comprises a function call and a value comprising text strings.

16. The method of claim 15, wherein:
the function call comprises a call to the BERT network; and
the BERT network is trained to determine a similarity between the timing parameters and text content of each attribute, associated with audio segments being tagged to the interviewer, and the respective timing data and content data of each predetermined rule.

17. The method of claim 16, further comprising determining the match between the attribute and the predetermined rule based on the determined similarity between the timing parameters and text content of the attribute and the respective timing data and content data of the predetermined rule being greater than a threshold value.

18. The method of claim 11, wherein:
each attribute associated with audio segments being tagged to the interviewer comprises a characterization of the text content of the attribute; and
the characterization is based on at least one of a verbosity, a content clarity, a concept clarity and a confidence of the interviewer during the conversation.

19. The method of claim 1, further comprising providing the notice to the user in real time during the conversation.

20. The method of claim 1, wherein the notice to the user comprises a summary of the conversation.
